(19) United States
(12) Patent Application Publication
(10) Pub. No.: US 2013/0205779 A1
(43) Pub. Date: Aug. 15, 2013

(54) Molecular Transformation Energy Conversion System

(71) Applicant: Jeffrey M. Lucas, Hopkins, MN (US)

(72) Inventor: Jeffrey M. Lucas, Hopkins, MN (US)

(21) Appl. No.: 13/764,474

(22) Filed: Feb. 11, 2013

Related U.S. Application Data
(60) Provisional application No. 61/597,003, filed on Feb. 9, 2012.

(51) Int. Cl. F02G 1/02

(52) U.S. Cl. CPC F02G 1/02
USPC 60/643

(57) ABSTRACT

A Molecular Transformation Energy Conversion System (MTECS), converts thermal energy to work energy. Unlike Rankine cycle engines that typically use a liquid to gas state change to extract work from the system, the MTECS uses a liquid to solid and/or austenite to martensite state change to extract work. Operation of the system involves extracting work from a thermally reactive material that changes in crystalline structure over a relatively small temperature range (as compared to Rankine cycle systems). Input thermal energy is transferred into either or both the thermal transfer component (typically a gas/liquid refrigerant) and/or the molecular transformation component (typically either water/ice or a shape memory material) to power the system. Sources of input thermal energy and methods of their transference into the system may be numerous.

### CROSS-REFERENCE TO RELATED APPLICATIONS

This application claims the benefit of U.S. Provisional Patent Application Ser. No. 61/597,003, filed Feb. 9, 2012, which application is hereby incorporated by reference in its entirety.

### BACKGROUND

In light of the many changes currently underway in the transportation and energy industry to convert to clean energy technologies, a tremendous need for clean energy storage systems has developed. As posted on Autocar on Oct. 16, 2011, Amsterdam is hoping to have 10,000 electric vehicles in operation by 2015 and have all cars in Amsterdam electric by 2040. The primary obstacle is the limitations of batteries as an energy storage device. Per kilogram, lithium air batteries produce 9 megajoules, while gasoline produces over 5 times the energy at 47.2 megajoules. In addition, gasoline reduces its weight to zero as the fuel is being used up, unlike batteries. If vehicles that are energized by electricity are to overtake fossil fuel vehicles, they will require significant advancements in the storage of that electric energy.

On the public utility front, much has been done to develop wind and solar power, both of which are inconsistent power sources. Because of their inconsistency, these systems would be well served to have a clean and efficient means for storing power for peak consumption periods. Although batteries may be a more viable option since weight is less of a concern for this application, batteries still contain materials that are not eco-friendly, which makes the production of huge battery storage units for public energy systems concerning. Consequently, some countries are turning to compressed or liquefied air systems as a more appealing alternative.

In the United States, there are a number of compressed air storage research projects underway, one of which is project being conducted at the University of Arizona together with Photovoltaic's maker Solon Corp. and the TuTRMTSon Electric Power Company. Research is also being conducted by other U.S. companies such as Air Products and Praxair.

Outside of the U.S., the UK and China are collaborating to build a cryogenic energy storage plant near London. According to Highview Power Storage Company, “the technology is scalable up to very large utility scale and is significantly cheaper than batteries.” According the article posted on Greenbang.com, the project has been supported by the UK's Department of Energy and Climate Change.

Benefits of compressed or liquefied air systems are many. Perhaps the most obvious is that the primary component is air—clean, simple, and readily available. In its simplest form (compressing and cooling air down to its liquid form to store it and then allowing it to warm through ambient heat input to drive a turbine or engine to recover the energy) is about as earth friendly as it gets. However, keeping it this simple and clean is a bit more challenging than it may first appear. Recovering the energy that goes into liquefying air (or at least most of it) is not as simple as just letting it warm up and then feeding the resulting pressurized air into an air motor.

There are significant losses in efficiency unless certain measures are taken to recover this energy. Although most cryogenic coolers are designed to be as efficient as possible (using some form of thermal regeneration), developments in cryogenic engines are less mature. For the most part, liquid air recovery engines rely on some form of supplemental heat input to boost the temperature differential to enhance the efficiency of the system. In a sense, this is a form of hybridizing the system as opposed to a purely liquid air energy storage and recovery system. Supplemental heat supplies might include geothermal sources (a good clean option but not always available), waste heat from industrial or power plants (a good way to get rid of something we don't want but again not always that accessible), or resorting to fuel burners (the least eco-friendly option).

The present invention is aimed at developing a type of recovery system that could extract most all of the energy stored in a thermal medium like liquid air without requiring a supplemental energy source to boost the temperature differential. The invention draws upon thermodynamic principles and thermal regeneration (as employed by the Stirling engine and other similar technologies) to increase the efficiency of a system with low temperature differentials. Developing technology that would allow high percentages of energy recovery from non-supplemented liquid air storage systems, for example, could provide optimal solutions for renewable public energy storage, widen the doorway for electric vehicles, and have a considerable positive impact on the environment.

Current low-temperature-differential systems/mechanisms for producing work have primarily focused on the use of thermally reactive shape memory materials in direct contact with a thermal energy source and fastened by a solid to solid connection to a work extracting device. The present invention describes a system wherein the thermal transfer component is distinct from the molecular transformation component and the molecular transformation component may or may not be fastened to the work transmitting component by a solid to solid connection. In addition, the actual input thermal energy is transferred into either or both the thermal transfer component (typically a gas/liquid refrigerant) and/or the molecular transformation component (typically either water/ice or a shape memory material) instead of only being transferred, by direct contact, to the molecular transformation component alone.

### SUMMARY

The claimed invention is a thermal energy to work energy conversion system wherein the transformation of the molecular structure of a substance between liquid and solid states and/or austenite and martensite states is used to produce work by causing the movement of a work producing device (for example, an engine piston or turbine blade or any other component—be it liquid, solid, electromagnetic, etc.) capable of transmitting a force over a distance. The primary components of the energy conversion system include: a thermal transfer component, a molecular transformation component, and a work transmitting component; although in some configurations, the molecular transformation and the work transmitting components may be combined into a single component provided the molecular transformation component either maintains a solid state throughout system operation or it has some other means of transmitting work while transforming between a liquid and solid state, as might be conceived when magnetic particles are suspended in a fluid or elastic material. The thermal transfer component will typically operate at a near constant pressure and be configured in such a way as to balance the work input and output involved with moving thermal energy back and forth between the thermal transfer and the molecular transformation components. When the compressible thermal transfer substance (CTTS) pressure is not counterbalanced the thermal transfer component includes one or more compressible thermal transfer substance enclosures configured in such a way as to extract work output from the pressure forces of one or more enclosure(s) as thermal energy is drawn out from the thermally reactive molecular transformation substance. In this way, most of the energy losses from compressing the fluid to move thermal energy into the thermally reactive molecular transformation substance are regained. When the CTTS pressure is counterbalanced the thermal transfer component includes two or more compressible thermal transfer substance enclosures configured in such a way as to counterbalance the pressure forces of one or more enclosure(s) against one or more other enclosure(s). In this way, the overall amount of work energy put into moving thermal energy into and out from the thermally reactive molecular transformation substance is greatly reduced.

The molecular transformation component is designed to produce as much working force as possible with the smallest temperature variation. The goal of the system is to maximize energy output and minimizing energy input (i.e., increase efficiency) while operating within a narrow temperature range. This is distinct from Rankine cycle conversion, which relies on higher temperature differentials to produce higher efficiencies. The system also differs from Rankin Cycle mechanisms in that heat is used to alter the molecular structure of the thermally reactive molecular transformation substance (TRMTS) as opposed to increasing the pressure of a working fluid by heating a constrained volume. Thermal transfer between the TRMTS and the compressible thermal transfer substance (CTTS) is more akin to the Carnot cycle (than the Rankine cycle) in that heat is transferred back and forth adiabatically. The diabatic thermal energy input is separate from thermal exchange between the TRMTS and the CTTS and takes place to restore enthalpy of fusion (liquid/solid and/or austenite/martensite state change) losses resulting from the work output. Consequently, the thermal energy input may be introduced into either or both the CTTS and/or the TRMTS. Energy input may be derived from any available sources including, but not limited to, petroleum or natural gas based fuels, coal, nuclear, wood, wind, solar, hydro, and/or energies stored in other forms like electricity or compressed gas.

### BRIEF DESCRIPTION OF THE DRAWINGS

FIGS. 1A and 1B show a simplified diagram of the preferred embodiment, which uses (liquid/solid) water as the thermally reactive molecular transformation substance (TRMTS) and dimethyl ether as the compressible thermal transfer substance (CTTS); and

FIG. 2 shows a parallel diagram of the preferred embodiment, which replaces the liquid/solid thermally reactive molecular transformation substance (water) with a martensitic transformation substance (nitinol).

### DETAILED DESCRIPTION

Reference will now be made in detail to examples of inventive aspects of the present disclosure which are illustrated in the accompanying drawings. Wherever possible, the same reference numbers will be used throughout the drawings to refer to the same or like parts.

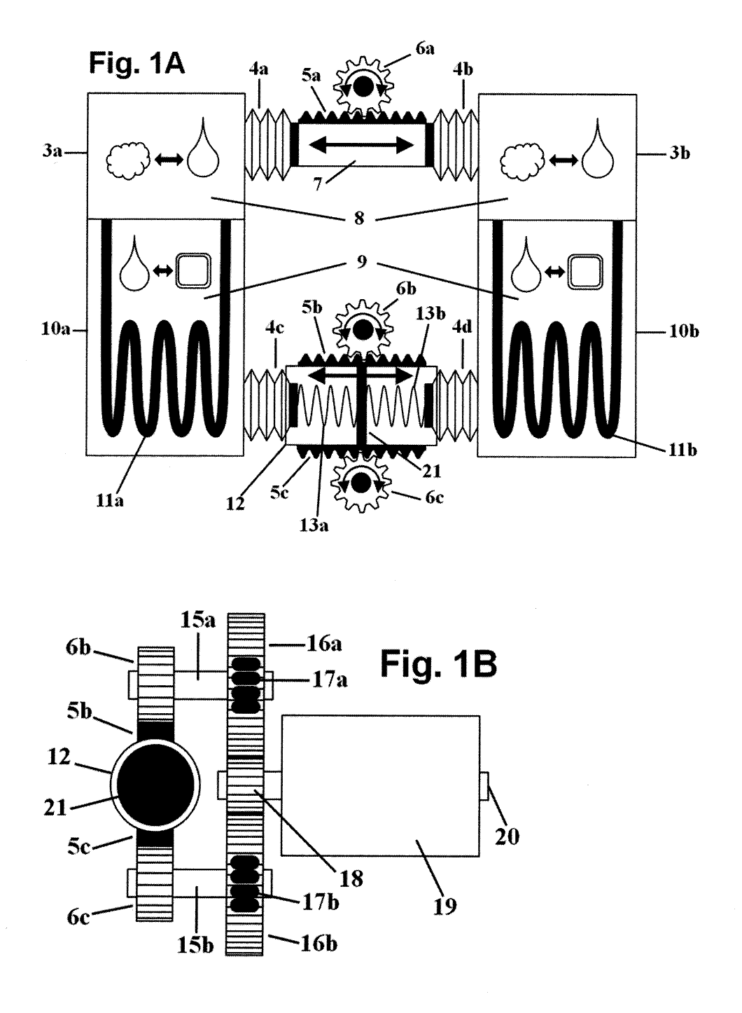

FIGS. 1A and 1B show a simplified diagram of the preferred embodiment, which uses (liquid/solid) water as the thermally reactive molecular transformation substance (TRMTS) and dimethyl ether as the compressible thermal transfer substance (CTTS). 3a and 3b represent enclosures for the compressible thermal transfer substance (CTTS) 8. 4a, 4b, 4c, and 4d represent expansion joints (or other types of fluid pressure to shaft work conversion devices, for example, pistons). Expansion joints 4a and 4b are used to alter the pressure within the CTTS enclosures 3a and 3b by means of a gear 6a that is driven by some work input source (for example, an electric motor). Gear 6a transmits rotary motion to gear rack 5a. Gear rack 5a is rigidly fastened to a bar/rod 7, which transmits linear motion to expansion joints 4a and 4b. This work input configuration for the CTTS may be of any mechanical design that accomplishes the same function of varying the pressure of the CTTS 8 within the CTTS enclosures 3a and 3b.

Ideally, the pressure within enclosures 3a and 3b remains nearly constant as heat energy is transferred into and out from the thermally reactive molecular transformation substance (TRMTS) 9 by means of the high surface area, high pressure accommodating coils 11a and 11b. Coils 11a and 11b are filled with the CTTS 8, which flows freely into and out of the coils from the CTTS enclosures 3a and 3b. The TRMTS 9 is isolated from the CTTS 8, remaining on the outside of the CTTS 8 filled coils. The TRMTS 9 is also contained in its own enclosure(s) 10a and 10b.

CTTS 8 would typically be a refrigerant, for example, dimethyl ether. Dimethyl ether would be a reasonable choice when using water as the TRMTS 9 because dimethyl ether changes phase (gas/liquid) at reasonably low pressure (approximately 50 psi) when at water's freezing point temperature of 32° F. When using a liquid/solid TRMTS 9 (as opposed to a martensitic transformation substance) water would be a reasonable choice since it has relatively high volumetric expansion (approximately 9%) over a small temperature differential when transforming from a liquid (water) to a solid (ice) state. In addition, significant pressures can be produced when water changes to ice. Some sources claim that ice can exert approximately 40,000 psi at −22° C. without melting (http://www.benbestcom/cryonics/pressure.html).

By maintaining a relatively consistent pressure on the CTTS 8, the system allows for a gradual and efficient thermal transfer of heat into and out from the TRMTS 9, by gradually increasing and decreasing the volume of the CTTS 8. Again using dimethyl ether as an example CTTS 8, the CTTS 8 can remain compressed just enough to have some of the substance liquefied and the remainder vaporized. In this way, the heat capacity and thermal conductivity of the (liquid) CTTS 8 can remain high and similar to the TRMTS 9 while still being easily compressible (vapor) to allow for effective thermal transfer between the CTTS 8 and the TRMTS 9. Increasing the volume of the CTTS 8 pulls heat from the TRMTS 9 and decreasing the volume of the CTTS 8 pushes heat back into the TRMTS 9 while pressure remains nearly constant because the increased volume contains a pressure balancing amount of additional heat and the decreased volume contains a pressure balancing amount less heat.

For the work harvesting portion of the system, expansion joints (or other types of fluid pressure to shaft work conversion devices, for example, pistons) 4c and 4d are used. Components 4c and 4d allow for the unfrozen portion of the TRMTS 9 to push against the driven members 5b, 5c, 6b and 6c. In this embodiment, a pair of gear sets (5b and 6b, 5c and 6c) are used on either side of force driven component 12, a tube shaped piece with a work transmitting wall 21 fixed inside at the center. (As with the input work portion of the system, the output work portion of the system may be configured in other ways—including, but not limited to gears, linkages, magnets, cams, etc.—as long as the function of the component is to transmit work.) Force driven component 12 is spring loaded by biasing members 13a and 13b to allow for the unequal movements of expansion joints 4c and 4d as the TRMTS 9 in each chamber 10a and 10b transforms back and forth between water and ice.

In short, gear 6a alternately compresses the CTTS 8 on either side of the system, which subsequently freezes and thaws a portion of the TRMTS 9 on either side of the system, the expansion and contraction of which drives gears 6b and 6c in alternating and opposing directional rotations. While gear 6b is rotating clockwise, gear 6c will be rotating counterclockwise, and when gear 6b changes to counterclockwise rotation, gear 6c will change to clockwise rotation.

FIG. 1B show one of many conceivable methods for translating the alternating and opposing oscillating rotations of gears 6b and 6c produced by the forceful alternating movements of the output work portion of the system. In this embodiment, shafts 15a and 15b are rigidly connected to gears 6b and 6c respectively. Shafts 15a and 15b have a unidirectional link to gears 16a and 16b by way of one-way clutches (or ratchets) 17a and 17b. Consequently, the final output to the final driving gear 18, shaft 20, and work utilizing component 19 (some sort of useful work mechanism like a generator, vehicle, industrial machine, etc.) is unidirectional. The need for such a unidirectional configuration may be rendered unnecessary by using a bidirectional work utilizing component like a bidirectional generator, in which case gear 6b could be connected directly to the drive shaft 20 of the work utilizing component 19.

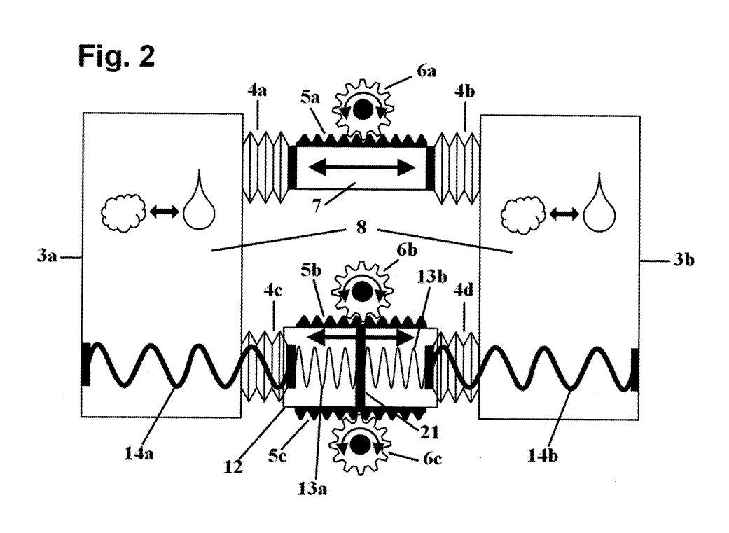

FIG. 2 shows a parallel diagram of the preferred embodiment, which replaces the liquid/solid thermally reactive molecular transformation substance (water) with a martensitic transformation substance (nitinol). In this second embodiment, nitinol wires 14a and 14b are depicted as the new TRMTS. Since these (continuously solid) TRMTS wires 14a and 14b will not mix with the CTTS 8 (liquid/vapor), they can be placed directly within the CTTS enclosures 3a and 3b, which eliminates the need for TRMSTS enclosures 10a and 10b. As thermal variations within the CTTS 8 are transferred into and out from the TRMTS wires 14a and 14b, the wires will expand and contract with similar effects on the output work portion of the system. The FIG. 2 configuration could likewise use any number of work transmitting components as were described above for use with the FIG. 1A configuration.

Having described the preferred aspects and embodiments of the present invention, modifications and equivalents of the disclosed concepts may readily occur to one skilled in the art. However, it is intended that such modifications and equivalents be included within the scope of the claims which are appended hereto.

1. A Molecular Transformation Energy Conversion System comprising:
a thermal transfer component that contains a compressible substance that conductively transfers thermal energy by being compressed at varying pressures and/or compressed and decompressed and/or compressed and expanded; and
a thermally reactive molecular transformation substance that is in thermal conductivity with the compressible thermal transfer substance and that changes in state due to temperature changes within the compressible thermal transfer substance.

2. The system of claim 1, further comprising means for transferring thermal energy into the system.

3. The system of claim 1, wherein an exchange of thermal energy between the compressible thermal transfer substance and the thermally reactive molecular transformation substance operates independent of the thermal energy input.

4. The system of claim 1, wherein an exchange of thermal energy between the compressible thermal transfer substance and the thermally reactive molecular transformation substance is dependent on the thermal energy input.

5. The system of claim 1, further comprising means for converting forceful movement of the thermally reactive molecular transformation substance into work.

6. The system of claim 4, wherein the thermally reactive molecular transformation substance is integral to the means for converting forceful movement of the thermally reactive molecular transformation substance into work.

7. The system of claim 4, wherein the thermally reactive molecular transformation substance is not integral to the means for converting forceful movement of the thermally reactive molecular transformation substance into work.

8. The system of claim 1, wherein the thermal transfer component includes one or more compressible thermal transfer substance enclosures configured in such a way as to extract work output from pressure forces of the one or more compressible thermal transfer substance enclosures as thermal energy is drawn out from the thermally reactive molecular transformation substance.

9. The system of claim 8, wherein energy that is lost from compressing the compressible substance to move thermal energy into the thermally reactive molecular transformation substance is optimally regained.

10. The system of claim 1, wherein the thermal transfer component includes two or more compressible thermal transfer substance enclosures configured in such a way as to counterbalance the pressure forces of one or more enclosures against one or more other enclosures.

11. The system of claim 10, wherein the overall amount of work energy needed to move thermal energy into and out from the thermally reactive molecular transformation substance is optimally reduced.
